(19) United States
(12) Patent Application Publication
(10) Pub. No.: US 2025/0390032 A1
(43) Pub. Date: Dec. 25, 2025

(54) POSITIVELY CHARGEABLE TONER

(71) Applicant: KYOCERA Document Solutions Inc., Osaka (JP)

(72) Inventor: Masashi YAMASHITA, Osaka (JP)

(73) Assignee: KYOCERA Document Solutions Inc., Osaka (JP)

(21) Appl. No.: 19/244,849

(22) Filed: Jun. 20, 2025

(30) Foreign Application Priority Data
Jun. 24, 2024 (JP) 2024-101332

(51) Int. Cl. G03G 9/093

(52) U.S. Cl. CPC G03G 9/09321

(57) ABSTRACT

The positively chargeable toner contains toner particles. Each of the toner particles includes a toner mother particle, and an external additive adhering to a surface of the toner mother particle. The external additive includes a resin-containing particle in which resin is contained. The resin-containing particle further contains an anionic surfactant. The resin-containing particle is surface treated with a silane coupling agent. A number-base-mean primary particle diameter of the resin-containing particles is within a range of 60 nm to 100 nm. An area ratio of a region covered by the resin-containing particle out of a surface region of the toner mother particle is within a range of 15% to 30%.

### INCORPORATION BY REFERENCE

This application is based on and claims the benefit of priority from Japanese Patent Application No. 2024-101332 filed on Jun. 24, 2024, the contents of which are hereby incorporated by reference.

### BACKGROUND

The present disclosure relates to a positively chargeable toner.

There has been a demand for a toner of higher transfer efficiency in association with image formation using image forming apparatuses.

### SUMMARY

A positively chargeable toner according to the present disclosure contains toner particles. Each of the toner particles includes a toner mother particle, and an external additive adhering to a surface of the toner mother particle. The external additive includes a resin-containing particle in which resin is contained. The resin-containing particle further contains an anionic surfactant. The resin-containing particle is surface treated with a silane coupling agent. A number-base-mean primary particle diameter of the resin-containing particles is within a range of 60 nm to 100 nm. An area ratio of a region covered by the resin-containing particle out of a surface region of the toner mother particle is within a range of 15% to 30%.

Further features of the present disclosure, and specific benefits obtained according to the present disclosure, will become more apparent from the description of an embodiment which follows.

### DETAILED DESCRIPTION

Before the description of an embodiment of the present disclosure proceeds below, issues in conventional related arts will be described first.

In conventional toners, for example, at least negatively chargeable resin particles and positively chargeable inorganic particles are adherently sticking to surfaces of toner mother particles.

However, above-described conventional toners are susceptible to improvement in terms of enhancement in transfer efficiency and moreover insufficient in charging stability.

In view of the above-described issues, an objective of the present disclosure is to provide a positively chargeable toner higher in transfer efficiency and superior in charging stability.

Hereinafter, an embodiment of the disclosure will be described. First, terms used herein are explained. The term ‘toner’ refers to an aggregation (e.g., powder) of toner particles. The term ‘external additive’ refers to an aggregation (e.g., powder) of external additive particles. Evaluation results (values indicating shape, physical properties, etc.) on powder (more specifically, powder of toner particles, powder of external additive particles, etc.), unless otherwise specified, are given as number-base means of values measured for each one of a considerable number of particles selected from powder. A cumulative 50% value (D₅₀) in volume-base particle size distribution of powder, unless otherwise specified, is given as a median diameter measured by a laser diffraction/scattering type particle size distribution analyzer (“LA-950” made by HORIBA, Ltd.). A number-base-mean primary particle diameter of powder, unless otherwise specified, is a number-base mean value of equivalent circle diameters of primary particles (Heywood diameter: a diameter of a circle having an arca equal to a projected area of primary particles) measured by using a scanning electron microscope. The number-base-mean primary particle diameter of powder is a number-base mean value of equivalent circle diameters of, e.g., 100 primary particles. An intensity of chargeability, unless otherwise specified, is a degree of easiness of frictional charging for standard carrier provided by the Imaging Society of Japan. For example, a measurement object is frictionally charged by stirring the measurement object and standard carrier (anionicity: N-01, cationicity: P-01) provided by the Imaging Society of Japan. For example, with use of a Q/m meter (“MODEL 212 HS” made by Trek, Inc.), charge amounts per unit mass of the measurement object are measured before and after the frictional charging, respectively, where it is indicated that the larger the change in charge amount per unit mass before and after the frictional charging, the stronger the chargeability of the measurement object. Unless otherwise specified, a melting point (Mp) is a temperature at a maximum endothermic peak of an endothermic curve (vertical axis: heat flow (DSC signal), horizontal axis: temperature) measured by a differential scanning calorimeter (“DSC-6220” made by Seiko Instruments Inc.). This endothermic peak appears due to melting of crystallizing sites. Hereinafter, there may be cases where, with ‘based’ suffixed to a compound name, the compound and its derivatives will generically be designated. In other cases where, with ‘based’ suffixed to a compound name to represent a polymer name, it is indicated that a repeating unit of the polymer is derived from the compound or one of its derivatives. There may be cases where acrylics and methacrylics are referred to generically as “(meth)acrylic.” There may be cases where acryloxy and methacryloxy are referred to generically as “(meth) acryloxy.” Individual constituents described herein may be given by one kind alone or by two or more kinds in combination. Here is ended the explanation of terms to be used herein.

### Positively Chargeable Toner

The positively chargeable toner according to this embodiment will be described below. The positively chargeable toner of this embodiment includes toner particles. The toner particles include toner mother particles, and external additives adhering to surfaces of the toner mother particles. The external additives include resin-containing particles in which resin is contained. The resin-containing particles further contain an anionic surfactant. The resin-containing particles are surface treated with a silane coupling agent. The number-base-mean primary particle diameter of the resin-containing particles is within a range of 60 nm to 100 nm. An area ratio of a region covered by the resin-containing particle out of a surface region of the toner mother particle is within a range of 15% to 30%.

Hereinafter, “positively chargeable toner” may be described simply as “toner” from time to time. Also, “an area ratio of a region covered by the resin-containing particle out of a surface region of the toner mother particle” may be described as “specified coverage rate” from time to time.

The toner of this embodiment, by virtue of its having the above-described configuration, is high in transfer efficiency and superior in charging stability. The reason of that is presumed as follows.

An external additive adhering to surfaces of the toner mother particles may be buried or eliminated due to mechanical stresses caused by stirring within a developing device. In order to suppress the burial or elimination of the external additive, large-diameter spacer particles may be contained in the external additive. When silica particles are used as the large-diameter spacer particles, there arises a need for positive-charging treatment of silica particles, causing a possibility that fogging or other failures may occur. On the other hand, when common resin particles are used as the spacer particles instead of silica particles, intense adhesion force of resin particles to the photosensitive drum is involved, so that adhesion force of toner particles to the photosensitive drum also becomes intense. For this reason, there is a tendency that toner particles are less likely to be transferred from the photosensitive drum to a paper sheet, with a result of degraded transfer efficiency.

Accordingly, in the toner of this embodiment, resin-containing particles contain an anionic surfactant. By virtue of resin-containing particles' containing the anionic surfactant, the resin-containing particles exhibit weak positive chargeability in frictional charging with the carrier. Since the resin-containing particles, which are spacer particles of high contact frequency with the photosensitive drum, exhibit weak positive chargeability, electrostatic adhesion force of toner particles to the photosensitive drum can be reduced.

Further, in the toner of this embodiment, resin-containing particles are surface treated with a silane coupling agent. By virtue of the surface treatment with the silane coupling agent, adhesion force of the resin-containing particles to the photosensitive drum can be reduced, so that adhesion force of the toner particles to the photosensitive drum can also be reduced.

Further, in the toner of this embodiment, the number-base-mean primary particle diameter of resin-containing particles is not less than 60 nm. On condition that the number-base-mean primary particle diameter of the resin-containing particles is not less than 60 nm, the resin-containing particles function enough as a spacer that reduces contact frequency between the photosensitive drum and the toner mother particles.

Further, in the toner of this embodiment, the specified coverage rate is not less than 15%. With a specified coverage rate of 15% or more, toner mother particles are sufficiently covered by the resin-containing particles. Therefore, resin-containing particles function enough as a spacer that reduces the contact frequency between the photosensitive drum and the toner mother particles.

By the reduction in adhesion force of the toner particles to the photosensitive drum, and by the reduction in contact frequency between the photosensitive drum and the toner mother particles, toner particles are more likely to separate from the photosensitive drum during transfer process, leading to an improvement in toner transfer efficiency.

On the other hand, given an excessively large number-base-mean primary particle diameter of resin-containing particles, resin-containing particles are more likely to be eliminated from toner mother particles. Also, given an excessively high specified coverage rate, quantity of the resin-containing particles becomes excessively large, so that the resin-containing particles are more likely to be eliminated from the toner mother particles. When the eliminated resin-containing particles adhere to the carrier, carrier contamination occurs, resulting in lowered charging stability of the toner. Thus, in the toner of this embodiment, the number-base-mean primary particle diameter of resin-containing particles is set to not more than 100 nm. Also in the toner of this embodiment, the specified coverage rate is set to not more than 30%. As a result of these settings, the resin-containing particles are less likely to be eliminated from the toner mother particles, so that carrier contamination can be suppressed. In consequence, toner charging stability is improved.

The above description has been given for the reason why the toner of this embodiment is higher in transfer efficiency and superior in charging stability.

### Toner Particles

Toner particles contained in the toner of this embodiment include toner mother particles and an external additive. The external additive is adherently sticking to surfaces of the toner mother particles. Toner containing toner particles is used as a positively chargeable toner suitably for development of electrostatic latent images. The toner mother particles are, for example, noncapsulate toner particles having no shell layer. However, the toner mother particles may instead be capsulate toner particles each including a toner core and a shell layer for covering the toner core. Also, toner is used, for example, as a two-component developer mixed with a carrier. However, toner may also be used as a one-component developer without being mixed with the carrier. In order to obtain toner suitable for image formation, the toner particles preferably have a value of D₅₀ ranging from 4 μm to 9 μm. Hereinbelow, external additives and toner mother particles included in the toner particles will be described.

### External Additives

An external additive contains resin-containing particles as external additive particles. The external additive may further contain, as required, external additive particles other than resin-containing particles.

### <Resin-Containing Particles>

As already mentioned, the number-base-mean primary particle diameter of resin-containing particles is within a range of 60 nm to 100 nm. In order to improve the transfer efficiency of toner, the number-base-mean primary particle diameter of resin-containing particles is preferably not less than 70 nm, more preferably not less than 75 nm. In order to improve the charging stability of toner, the number-base-mean primary particle diameter of resin-containing particles is preferably not more than 90 nm, more preferably not more than 85 nm.

As already mentioned, the specified coverage rate is within a range of 15% to 30%. In order to improve the transfer efficiency of toner, the specified coverage rate is preferably not less than 20%. In order to improve the charging stability of toner, the specified coverage rate is preferably not more than 25%. The specified coverage rate is measured by the same method as described in later-described Examples or a method compliant therewith. The specified coverage rate can be adjusted by, for example, changing both or either one of the addition amount of resin-containing particles relative to the mass of the toner mother particles and the kind of the resin-containing particles.

In order to adjust the specified coverage rate to a value within a desired range, content of resin-containing particles is preferably within a range of 0.7 part by mass to 1.3 parts by mass relative to 100.0 parts by mass of toner mother particles, and more preferably within a range of 0.8 part by mass to 1.2 parts by mass.

The external additive may contain resin-containing particles alone as external additive particles, and may also contain external additive particles other than the resin-containing particles. The content ratio of the resin-containing particles in the external additive particles is preferably within a range of 30 mass % to 50 mass %, and more preferably within a range of 35 mass % to 45 mass %.

The resin-containing particles contain resin. The resin-containing particles further contain an anionic surfactant. The resin-containing particles are surface treated with a silane coupling agent. Hereinafter, “resin-containing particles before being surface treated with a silane coupling agent” may be referred to as “untreated particles” from time to time.

### (Resin)

A content ratio of resin in the resin-containing particles is preferably within a range of 80 mass % to 99 mass %, more preferably within a range of 85 mass % to 95 mass %, and even more preferably within a range of 89 mass % to 91 mass %.

In order to obtain toner high in transfer efficiency and superior in charging stability, resins contained in the resin-containing particles preferably include styrene acrylic resin, and more preferably include styrene acrylic resin containing a silane bond. The silane bond is expressed by chemical formula “—SiR₂—.” In the chemical formula “—SiR₂—,” R represents a hydrogen atom or an alkyl group. By virtue of styrene acrylic resin's containing a silane bond, adhesion force of the resin-containing particles to the photosensitive drum can be reduced to more extent.

In order to further reduce adhesion force of the resin-containing particles to the photosensitive drum, the styrene acrylic resin containing a silane bond is preferably given by a polymer of styrene or its derivatives, (meth) acrylic acid or its derivatives, a silane compound having at least one (meth)acryloxy group, and a crosslinking agent having at least two unsaturated bonds. Hereinafter, “styrene or its derivatives” may be referred to as “styrene-based monomer” as appropriate. Also, “(meth)acrylic acid or its derivatives” may be referred to as “acrylic acid-based monomer” as appropriate.

The styrene-based monomer may be exemplified by styrene, alkylstyrene, hydroxystyrene, and styrene halide. The alkylstyrene may be exemplified by α-methylstyrene, m-methylstyrene, p-methylstyrene, p-ethylstyrene, and 4-t-buthylstyrene. The hydroxystyrene may be exemplified by p-hydroxystyrene and m-hydroxystyrene. The styrene halide may be exemplified by α-chlorostyrene, o-chlorostyrene, m-chlorostyrene, and p-chlorostyrene. The styrene-based monomer is preferably given by styrene. Styrene-based monomers have no silane bond, for example. A content ratio of the constitutional repeating unit derived from styrene-based monomers in resins is preferably within a range of 25 mass % to 40 mass %, and more preferably, within a range of 30 mass % to 35 mass %.

The acrylic acid-based monomer may be exemplified by (meth)acrylic acid, (meth)acrylamide, (meth)acrylonitrile, (meth)acrylic acid alkyl esters, and (meth)acrylic acid hydroxyalkyl esters. The (meth)acrylic acid alkyl esters may be exemplified by methyl (meth)acrylate, ethyl(meth)acrylate, n-propyl (meth)acrylate, isopropyl (meth)acrylate, n-butyl (meth)acrylate, isobutyl (meth)acrylate, and 2-ethylhexyl acrylate. The (meth)acrylic acid hydroxyalkyl esters may be exemplified by 2-hydroxyethyl (meth)acrylate, 3-hydroxypropyl (meth)acrylate, 2-hydroxypropyl (meth)acrylate, and 4-hydroxybutyl (meth)acrylate. The acrylic acid-based monomer may be exemplified by preferably (meth)acrylic acid alkyl esters, more preferably (meth)acrylic acid alkyl esters of an alkyl group with a carbon atomicity of 1 to 3, even more preferably methyl (meth)acrylate, and particularly preferably methyl methacrylate. The acrylic acid-based monomer, for example, has no silane bond. A content ratio of the constitutional repeating unit derived from acrylic acid-based monomers in resins is preferably within a range of 35 mass % to 50 mass %, and more preferably, within a range of 40 mass % to 45 mass %.

A silane compound having at least one (meth)acryloxy group has a silane bond. Using, as a monomer, a silane compound having at least one (meth) acryloxy group makes it possible to introduce a silane bond to styrene acrylic resin.

The silane compound having at least one (meth)acryloxy group may be exemplified by, preferably, a silane coupling agent having at least one (meth)acryloxy group. Hereinafter, a “silane coupling agent for surface treating resin-containing particles” may be referred to as “surface-treatment silane coupling agent,” and a “silane coupling agent for synthesizing a resin contained in resin-containing particles” may be referred to as “resin-synthesization silane coupling agent,” from time to time. When the constitutional repeating unit derived from a resin-synthesization silane coupling agent is introduced into resin, there occurs, during surface treatment process, a condensation reaction between a silanol group produced by hydrolyzation of an alkoxysilyl group in the constitutional repeating unit derived from the resin-synthesization silane coupling agent, and a silanol group produced by hydrolyzation of the surface-treatment silane coupling agent, thus facilitating the surface treatment.

The resin-synthesization silane coupling agent having a (meth) acryloxy group may be exemplified by 3-(meth)acryloxypropylalkyldialkoxysilane, and 3-(meth)acryloxypropyltrialkoxysilane. The 3-(meth)acryloxypropylalkyldialkoxysilane may be exemplified by 3-methacryloxypropylmethyldimethoxysilane, and 3-methacryloxypropylmethyldicthoxysilane. The 3-(meth)acryloxypropyltrialkoxysilane may be exemplified by 3-methacryloxypropyltrimethoxysilane, 3-methacryloxypropyltriethoxysilane, and 3-acryloxypropyltrimethoxysilane. The silane compound having at least one (meth)acryloxy group may be preferably 3-methacryloxypropylmethyldiethoxysilane. The content ratio of the constitutional repeating unit derived from the silane compound having at least one (meth)acryloxy group in resins is preferably within a range of 5 mass % to 20 mass %, more preferably within a range of 10 mass % to 15 mass %.

The unsaturated bond contained in the crosslinking agent may be exemplified by a carbon-carbon double bond. The crosslinking agent having two or more unsaturated bonds may be exemplified by N,N′-methylene bisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate. The crosslinking agent having two or more unsaturated bonds is preferably ethylene glycol dimethacrylate. The crosslinking agent having two or more unsaturated bonds, for example, has no silane bond. The content ratio of the constitutional repeating unit derived from the crosslinking agent having two or more unsaturated bonds in resins is preferably within a range of 5 mass % to 20 mass %, and more preferably within a range of 10 mass % to 15 mass %.

### (Anionic Surfactant)

In order to further reduce electrostatic adhesion force of toner particles to the photosensitive drum, the anionic surfactant preferably has a sulfuric acid anionic group (—O—SO₂—O— group) or a sulfonic acid anionic group (-SO2-O-group). The anionic surfactant having a sulfuric acid anionic group may be exemplified by an alkylsulfuric acid ester salt having an alkyl group with a carbon number of 10 to 25, more specifically sodium lauryl sulfate. The anionic surfactant having a sulfonic acid anionic group may be exemplified by an alkyl benzene sulfonate having an alkyl group with a carbon number of 10 to 25, more specifically sodium dodecylbenzenesulfonate.

The resin-containing particles can be manufactured, for example, by producing polymerization reaction of monomers in a liquid containing monomers for resin synthesization and the anionic surfactant. In the polymerization reaction, the anionic surfactant tends to be oriented at an interface between the monomers and the liquid. Therefore, after the polymerization reaction, untreated particles are taken out from within the liquid, and then, without being cleaned (or without complete removal of the anionic surfactant present on the surfaces of the untreated particles in a cleaning process), the untreated particles are surface treated with the surface-treatment silane coupling agent. By so doing, the anionic surfactant is allowed to be present in proximities of the surfaces of the resin-containing particles (e.g., on surfaces of the untreated particles). More specifically, the proximities of the surfaces of the resin-containing particles are positioned on the surfaces of base-material particles consisting of resin, and moreover inside a surface-treatment layer of the silane coupling agent. In this case, each of the resin-containing particles includes a base-material particle consisting of resin, an anionic surfactant adhering to a surface of the base-material particle, and a surface-treatment layer of the silane coupling agent covering the base-material particle with the anionic surfactant adhering thereto. In this case, the anionic surfactant exists between the surface of the base-material particle and the surface-treatment layer. Such placement of the anionic surfactant yields even further reduction of positive chargeability of the resin-containing particles. In consequence, electrostatic adhesion force of toner particles to the photosensitive drum can be reduced to more extent.

In order to further reduce electrostatic adhesion force of the toner particles to the photosensitive drum, a content rate of the anionic surfactant in surface regions of the resin-containing particles is preferably set higher than a content rate of the anionic surfactant in internal regions of the resin-containing particles. The surface regions of the resin-containing particles are regions, for example, which include surfaces of the resin-containing particles and extend over a depth measuring a tenth of the radius of the resin-containing particles along a direction from surface toward center. The internal region of each resin-containing particle is, for example, a spherical region about the center of the resin-containing particle, where the radius of the internal region measures, for example, a tenth of the radius of the resin-containing particle.

In order to further reduce the electrostatic adhesion force of toner particles to the photosensitive drum, a ratio Ws/Wr of a mass Ws of the anionic surfactant to a mass Wr of the resin is preferably within a range of 0.01 to 0.50, more preferably within a range of 0.05 to 0.20, even more preferably within a range of 0.10 to 0.12.

In order to further reduce the electrostatic adhesion force of toner particles to the photosensitive drum, the content ratio of the surfactant in the resin-containing particles is preferably within a range of 1 mass % to 20 mass %, more preferably within a range of 5 mass % to 15 mass %, and even more preferably within a range of 9 mass % to 11 mass %.

### (Surface-Treatment Silane Coupling Agent)

When surfaces of untreated particles have been treated with the surface-treatment silane coupling agent, silanol groups (—SiOH groups) produced by hydrolyzation of the surface-treatment silane coupling agent are brought into self condensation reaction at surfaces of the untreated particles. Also, in a case where untreated particles have, at their surfaces, hydroxyl groups (e.g., silanol groups produced by hydrolyzation of an alkoxysilyl group in the constitutional repeating unit derived from the resin-synthesization silane coupling agent), there occurs condensation reaction of hydroxyl groups present on the surfaces of the untreated particles and silanol groups (—SiOH groups) produced by hydrolyzation of the surface-treatment silane coupling agent.

The surface-treatment silane coupling agent may be identical in chemical structure to the resin-synthesization silane coupling agent. However, because of easier surface treatment of the resin-containing particles, the surface-treatment silane coupling agent is preferably different in chemical structure from the resin-synthesization silane coupling agent. For example, the surface-treatment silane coupling agent may be without (meth)acryloxy groups.

The surface-treatment silane coupling agent may be exemplified by alkylalkoxysilane. The alkylalkoxysilane preferably has an alkyl group with a carbon atomicity of 3 to 8. The alkylalkoxysilane preferably has an alkoxy group with a carbon atomicity of 1 to 3.

The alkylalkoxysilane may be exemplified by propyltrimethoxysilane (more specifically, n-propyltrimethoxysilane, isopropyltrimethoxysilane, etc.), propyltriethoxysilane (more specifically, n-propyltriethoxysilane, isopropyltriethoxysilane, etc.), butyltrimethoxysilane (more specifically, n-butyltrimethoxysilane, isobutyltrimethoxysilane, etc.), butyltriethoxysilane (more specifically, n-butyltriethoxysilane, isobutyltriethoxysilane, etc.), hexyltrimethoxysilane (more specifically, n-hexyltrimethoxysilane, etc.), hexyltriethoxysilane (more specifically, n-hexyltriethoxysilane, etc.), octyltrimethoxysilane (more specifically, n-octyltrimethoxysilane, etc.), and octyltriethoxysilane (more specifically, n-octyltriethoxysilane, etc.). The surface-treatment silane coupling agent is preferably isobutyltrimethoxysilane or propyltrimethoxysilane.

In order to further reduce the adhesion force of toner particles to the photosensitive drum, the content of the surface-treatment silane coupling agent is preferably within a range of 0.1 part by mass to 5.0 parts by mass relative to 50.0 parts by mass of untreated particles, more preferably within a range of 0.5 part by mass to 3.0 parts by mass, and even more preferably within a range of 0.8 part by mass to 1.3 parts by mass.

In order to further reduce the adhesion force of toner particles to the photosensitive drum, the content ratio of the surface-treatment silane coupling agent in the resin-containing particles is preferably within a range of 0.1 mass % to 5.0 mass %, more preferably within a range of 1.0 mass % to 3.0 mass %, and even more preferably within a range of 1.5 mass % to 2.5 mass %.

### (Manufacturing Process for Resin-Containing Particles)

As already described, the resin-containing particles can be manufactured, for example, by producing polymerization reaction of monomers in a liquid containing monomers for resin synthesization and the anionic surfactant. The number-base-mean primary particle diameter of the resin-containing particles can be adjusted, for example, by changing at least one of liquid stirring rate in the polymerization reaction and reaction time of the polymerization reaction. The higher the liquid stirring rate in the polymerization reaction, the smaller the number-base-mean primary particle diameter of the resin-containing particles. Also, the shorter the reaction time of the polymerization reaction, the smaller the number-base-mean primary particle diameter of the resin-containing particles.

### <Other External Additive Particles>

Among other external additives are, for example, inorganic particles, which include, more specifically, silica particles and particles of metal oxides (concretely, alumina, titanium oxide, magnesium oxide, zinc oxide, strontium titanate, and barium titanate, etc.). Surfaces of other external additive particles may be subjected to either one or both of positively charging process and hydrophobizing process. The number-base-mean primary particle diameter of other external additive particles is preferably within a range of 5 nm to 80 nm. The content of the external additive particles is preferably within a range of 0.1 part by mass to 5.0 parts by mass relative to 100.0 parts by mass of toner mother particles, more preferably within a range of 1.0 part by mass to 2.0 parts by mass. The content ratio of the other external additive particles in the external additive particles is preferably within a range of 50 mass % to 70 mass %, more preferably within a range of 55 mass % to 65 mass %.

### Toner Mother Particles

The toner mother particles contain a binder resin. The toner mother particles may further contain, in addition to the binder resin, internal additives (e.g., at least one of a colorant, a release agent, a charge control agent, and other constituents different from the above-described ones) as required.

### <Binder Resin>

In the toner mother particles, the binder resin occupies 70 mass % or more of all the constituents as an example. Accordingly, it is inferred that properties of the binder resin largely affect properties of the toner mother particles as a whole. Using plural kinds of resins in combination as the binder resin enables adjustment of properties (more specifically, glass transition point etc.) of the binder resin.

In order to obtain toner superior in low-temperature fixability, the toner mother particles, preferably, contain a thermoplastic resin as the binder resin, and more preferably, contain a thermoplastic resin at a ratio of 85 mass % or more of the whole binder resin. The thermoplastic resin may be exemplified by styrene resin, acrylic ester resin, olefin resin (more specifically, polyethylene resin, polypropylene resin, etc.), vinyl resin (more specifically, vinyl chloride resin, polyvinyl alcohol, vinyl ether resin, N-vinyl resin, etc.), polyester resin, polyamide resin, and urethane resin. Moreover, copolymers of these resins, i.e., copolymers in which any arbitrary repeating unit is introduced into the resin (more specifically, styrene acrylic resin, styrene-butadiene resin, etc.) are also usable as the binder resin.

In order to obtain toner superior in low-temperature fixability, the toner mother particles preferably contain polyester resin as the binder resin, more preferably contain polyester resin at a ratio within a range of 80 mass % to 100 mass % of the whole binder resin. The polyester resin is obtained by condensation-polymerizing one or more kinds of polyhydric alcohols and one or more kinds of polycarboxylic acids. The polyhydric alcohols for synthesization of polyester resin may be exemplified by dihydric alcohol (more specifically, aliphatic diol, bisphenol, etc.), and tri-or more-hydric alcohols, as shown below. The polycarboxylic acid for synthesization of polyester resin may be exemplified by dicarboxylic acid, and tri- or more-carboxylic acid, as shown below. It is noted that instead of polycarboxylic acids, polycarboxylic acid derivatives capable of forming ester linkage by condensation polymerization of polycarboxylic acid anhydride, polycarboxylic acid halide or the like may also be used.

The aliphatic diol, which is a specific example of dihydric alcohols, may be exemplified by diethylene glycol, triethylene glycol, neopentyl glycol, 1,2-propanediol, α,ω-alkanediol (more specifically, ethylene glycol, 1,3-propanediol, 1,4-butanediol, 1,5-pentanediol, 1,6-hexanediol, 1,7-heptanediol, 1,8-octanediol, 1,9-nonanediol, 1,12-dodecanediol, etc.), 2-butene-1, 4-diol, 1,4-cyclohexane dimethanol, dipropylene glycol, polyethylene glycol, polypropylene glycol, and polytetramethylene glycol.

The bisphenol, which is a specific example of dihydric alcohols, may be exemplified by bisphenol A, hydrogenated bisphenol A, bisphenol A ethylene oxide adducts, and bisphenol A propylene oxide adducts.

The tri- or more-hydric alcohol may be exemplified by sorbitol, 1,2,3,6-hexanetetrol, 1,4-sorbitan, pentaerythritol, dipentacrythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

The dicarboxylic acid may be exemplified by maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, 1,10-decanedicarboxylic acid, succinic acid, and alkylsuccinic acid (more specifically, n-butylsuccinic acid, isobutylsuccinic acid, n-octylsuccinic acid, n-dodecylsuccinic acid, isododecylsuccinic acid, and alkenylsuccinic acid (more specifically, n-butenylsuccinic acid, isobutenylsuccinic acid, n-octenylsuccinic acid, n-dodecenylsuccinic acid, isododecenylsuccinic acid, etc.).

The tri-or more-carboxylic acid may be exemplified by 1,2,4-benzenetricarboxylic acid (i.e., trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra (methylenecarboxyl) methane, 1,2,7,8-octanetetracarboxylic acid, pyromellitic acid, and Empol trimer acid.

The polyester resin is, preferably, a condensation-polymerization product of at least one kind of bisphenol, a dicarboxylic acid, and a tricarboxylic acid. The polyester resin is, more preferably, a condensation-polymerization product of a bisphenol A ethylene oxide adduct, a bisphenol A propylene oxide adduct, fumaric acid, and trimellitic acid.

In order to obtain toner superior in low-temperature fixability, the polyester resin is preferably amorphous. For amorphous polyester resins, their definite melting point is unmeasurable in many cases. Accordingly, it is appropriate that a polyester resin which does not permit a decision of having a definite endothermic peak in its endothermic curve measured by a differential scanning calorimeter is regarded as an amorphous polyester resin.

### <Colorants>

As the colorants, well-known pigments or dyes commensurate with colors of toner may be used. In order to form high-quality images with toner, it is preferable that the quantity of colorants is within a range of 1 part by mass to 20 parts by mass relative to 100 parts by mass of the binder resin.

The toner mother particles may contain a black colorant. The black colorant may be exemplified by carbon black. The black colorant may instead be a colorant blackened through toning with use of a yellow colorant, a magenta colorant, and a cyan colorant.

The toner mother particles may contain color colorants. The color colorants may be exemplified by a yellow colorant, a magenta colorant, and a cyan colorant.

Usable for the yellow colorant are, for example, one or more kinds of compounds selected from a group consisting of condensed azo compounds, isoindolinone compounds, anthraquinone compounds, azo metal complexes, methine compounds, and arylamide compounds. The yellow colorant may be exemplified by C.I. pigment yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, and 194), naphthol yellow S, Hansa yellow G, and C.I. Vat yellow.

Usable for the magenta colorant are, for example, one or more kinds of compounds selected from a group consisting of condensed azo compounds, diketopyrrolopyrrole compounds, anthraquinone compounds, quinacridone compounds, basic-dye lake compounds, naphthol compounds, benzimidazolone compounds, thioindigo compounds, and perylene compounds. The magenta colorant may be exemplified by C.I. pigment red (2, 3, 5, 6, 7, 19, 23, 48:2, 48:3, 48:4, 57:1, 81:1, 122, 144, 146, 150, 166, 169, 177, 184, 185, 202, 206, 220, 221, and 254).

Usable for the cyan colorant are, for example, one or more kinds of compounds selected from a group consisting of copper phthalocyanine compounds, anthraquinone compounds, and basic-dye lake compounds. The cyan colorant may be exemplified by C.I. pigment blue (1, 7, 15, 15:1, 15:2, 15:3, 15:4, 60, 62, and 66), phthalocyanine blue, C.I. Vat blue, and C.I. acid blue.

### <Mold Releasing Agent>

The mold releasing agent is used with an aim of, for example, obtaining toner superior in anti-offset property. In terms of obtainment of toner superior in anti-offset property, quantity of the mold releasing agent is preferably within a range of 1 part by mass to 20 parts by mass relative to 100 parts by mass of the binder resin. The mold releasing agent may be exemplified by ester wax, polyolefine wax (more specifically, polyethylene wax, polypropylene wax, etc.), microcrystalline wax, fluororesin wax, Fischer-Tropsch wax, paraffin wax, candelilla wax, montan wax, and Caster wax. The ester wax may be exemplified by natural ester wax (more specifically, carnauba wax, rice bran wax, etc.), and synthetic ester wax.

### <Charge Control Agent>

The charge control agent is used with an aim of, for example, obtaining toner superior in charging stability and charging rising characteristic. The charging rising characteristic of toner serves as an index as to whether or not toner can be charged up to a specified charging level in short time. In order to obtain toner superior in charging stability, content of the charge control agent is preferably within a range of 0.1 part by mass to 20 parts by mass relative to 100 parts by mass of the binder resin. Getting the positively chargeable charge control agent contained in the toner mother particles allows the toner mother particles to be strengthened in cationicity (positive chargeability). The positively changeable charge control agent may be exemplified by: azine compounds such as pyridazine, pyrimidine, pyrazine, 1,2-oxazine, 1,3-oxazine, 1,4-oxazine, 1,2-thiazine, 1,3-thiazine, 1,4-thiazine, 1,2,3 -triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes such as azine fast red FC, azine fast red 12BK, azine violet BO, azine brown 3G, azine light brown GR, azine dark green BH/C, azine deep black EW, and azine deep black 3RL; acid dyes such as nigrosine BK, nigrosine NB, and nigrosine Z; alkoxylated amines; alkyl amides; quaternary ammonium salts such as benzyldecylhexylmethyl ammonium chloride, decyltrimethyl ammonium chloride, 2-(methachryloyloxy) ethyltrimethyl ammonium chloride, dimethylaminopropylacrylamide methylchloride quaternary salts; and resins including quaternary ammonium cationic groups.

### <Other Constituents>

The other constituents that may be contained in the toner mother particles are exemplified by magnetic powder, compatibilizer, and well-known additives other than the above-described ones.

### Manufacturing Process for Toner

A manufacturing process for toner according to this embodiment includes, for example, a preparation step for toner mother particles, and an external addition step.

### <Preparation Step for Toner Mother Particles>

In a preparation step for toner mother particles, the toner mother particles are formed by coagulation process or grinding process.

The coagulation process includes, for example, a coagulation step and a coalescence step. In the coagulation step, impalpable particles containing constituents of toner mother particles are coagulated in an aqueous medium to form coagulated particles. In the coalescence step, constituents contained in the coagulated particles are coalesced in the aqueous medium to form toner mother particles.

Next, the grinding process is explained. With the grinding process adopted, not only the toner mother particles can be prepared comparatively simply, but also reduction of the manufacturing cost becomes practicable. When the toner mother particles are prepared by the grinding process, the preparation process of the toner mother particles includes, for example, a kneading step and a grinding step. The manufacturing process of the toner mother particles may further include a mixing step before the kneading step. Also, the preparation process of the toner mother particles may further include at least one of a fine grinding step and a classification step in succession to the grinding step.

In the mixing step, the binder resin and the internal additives to be added as required are mixed together to yield a mixture. In the kneading step, toner materials, while being melted, are kneaded to yield a kneaded product. The toner materials are, for example, a mixture yielded by the mixing step. In the grinding step, the resulting kneaded product is cooled to room temperature (25° C.), as an example, and ground to yield a ground product. When the ground product obtained by the grinding step needs to be downsized in diameter, a step (fine grinding step) for further grinding the ground product may also be executed. Also, when the ground product is uniformized in particle diameter, a step (classification step) for classifying the resulting ground product may also be executed. As a result of the above-described steps, toner mother particles that are the ground product are obtained.

### <External Addition Step>

In an external addition step, the resulting toner mother particles and an external additive are mixed together with a mixer so as to make the external additive adhering to surfaces of the toner mother particles. The external additive contains at least resin-containing particles. When the external additive is put into adhesion by mixing, the toner mother particles and the external additive particles are kept from mutual chemical reaction to remain fixed not chemically but physically. The mixer may be exemplified by an FM mixer (made by Nippon Coke & Engineering Co., Ltd.). Thus, toner containing toner particles is manufactured.

### Examples>

Hereinafter, Examples of the present disclosure will be described, whereas it should be construed that the present disclosure is not limited to the scope of those Examples at all.

### <Surfactants>

Surfactants to be used for preparation of resin-containing particles are as follows:
surfactant (S-1a): sodium lauryl sulfate (type: anionic surfactant having a sulfuric acid anionic group);
surfactant (S-2A): sodium dodecylbenzenesulfonate (type: anionic surfactant having a sulfuric acid anionic group);
surfactant (S-3c): n-hexadecyltrimethylammonium chloride (type: cationic surfactant); and
surfactant (S-4n): polyoxyethylene lauryl ether (type: nonionic surfactant).

### Surface Treatment Agents

Surface treatment agents to be used for preparation of resin-containing particles are as follows:
surface treatment agent (IBTMS): isobutyltrimethoxysilane; and
surface treatment agent (PTMS): propyltrimethoxysilane.

### Preparation of Resin-Containing Particles

Resin-containing particles to be used in the external addition step were prepared by the following process. Blend conditions of individual resin-containing particles are shown in Table 1 below. Also, preparation conditions and number-base-mean primary particle diameters of the individual resin-containing particles are shown in Table 2 below.

Table 1 is as follows.

TABLE 1

| | Resin | | | | | | | |
|---|---|---|---|---|---|---|---|---|
| | | | | Cross- | | | Surface treatment | |
| Resin- | | | | linking | | | agent | |
| containing | MM | ST | MSi | agent | Surfactant | | | [parts/ |
| particles | [parts] | [parts] | [parts] | [parts] | Type | [parts] | Type | 50.0 parts] |
| RA-1 | 60 | 45 | 15 | 15 | S-1a | 15 | IBTMS | 1.0 |
| RA-2 | 60 | 45 | 15 | 15 | S-1a | 15 | PTMS | 0.8 |
| RA-3 | 60 | 45 | 15 | 15 | S-1a | 15 | IBTMS | 0.8 |
| RA-4 | 60 | 45 | 15 | 15 | S-1a | 15 | IBTMS | 1.3 |
| RA-5 | 60 | 45 | 15 | 15 | S-2a | 15 | IBTMS | 1.0 |
| RB-1 | 60 | 45 | 15 | 15 | S-3c | 15 | IBTMS | 1.0 |
| RB-2 | 60 | 45 | 15 | 15 | S-4n | 20 | IBTMS | 1.0 |
| RB-3 | 60 | 45 | 15 | 15 | S-1a | 15 | — | — |
| RB-4 | 60 | 45 | 15 | 15 | S-1a | 15 | IBTMS | 0.8 |
| RB-5 | 60 | 45 | 15 | 15 | S-1a | 15 | IBTMS | 1.3 |

Table 2 is as follows:

TABLE 2

| Resin-containing | Reaction time X | Stirring time Y | Diameter |
|---|---|---|---|
| particles | [time] | [rpm] | [nm] |
| RA-1 | 3.0 | 800 | 78 |
| RA-2 | 3.0 | 800 | 78 |
| RA-3 | 3.0 | 700 | 99 |
| RA-4 | 3.5 | 900 | 62 |
| RA-5 | 3.0 | 800 | 80 |
| RB-1 | 3.0 | 800 | 75 |
| RB-2 | 3.0 | 800 | 70 |
| RB-3 | 3.0 | 800 | 78 |
| RB-4 | 3.0 | 650 | 101 |
| RB-5 | 3.5 | 950 | 58 |

Abbreviations used in Tables 1 and 2 are as follows:
parts: parts by mass;
parts/50.0 parts: quantity of surface treatment agents relative to 50.0 parts by mass of untreated particles (unit: parts by mass);
MM: methyl methacrylate;
ST: styrene;
MSi: 3-methacryloxypropyl methyldiethoxysilane;
crosslinking agent: ethylene glycol dimethacrylate;
-: nonuse of corresponding constituent; and
diameter: number-base-mean primary particle diameter.

### <Measurement Method of Number-Base-Mean Primary Particle Diameter>

Number-base-mean primary particle diameters of resin-containing particles shown in Table 2 were measured by using a scanning electron microscope (JSM-7600F made by JEOL Ltd.). For measurement of the primary particle diameters, equivalent circle diameters (Heywood diameter: diameter of a circle having an area equal to a projected area of primary particles) of primary particles of 100 resin-containing particles were measured and their number-base mean values were determined.

$$〈 \text{Resin-containing particles} ( RA - 1 ) 〉$$

600 parts by mass of ion-exchanged water, 10 parts by mass of benzoyl peroxide as an initiator, 60 parts by mass of methyl methacrylate, 45 parts by mass of styrene, 15 parts by mass of 3-methacryloxypropyl methyldiethoxysilane, 15 parts by mass of ethylene glycol dimethacrylate as a crosslinking agent, and 15 parts by mass of surfactant (S-1a) were put into a four-necked flask equipped with a stirring device, a cooling tube, a thermometer, and a nitrogen introducing tube. While the flask contents were being stirred, nitrogen gas was introduced into the flask, causing the flask inside to be under a nitrogen atmosphere. Subsequently, while the flask contents were being stirred, temperature of the flask contents were raised to 90° C. under the nitrogen atmosphere. Then, under the conditions of the nitrogen atmosphere and temperature of 90° C., the flask contents, while being stirred at a stirring rate of 800 rpm (hereinafter, stirring rate Y), were let to react for three hours (hereinafter, reaction time X) to yield an emulsion containing reaction products. The resulting emulsion was dried with use of a spray drier to yield untreated particles. Then, while being stirred within a stirrer-equipped stainless container, 50.0 parts by mass of untreated particles were sprayed with 1.0 part by mass of a surface treatment agent (IBTMS). After an end of the spraying, the container contents were allowed to stay under a nitrogen atmosphere at 60° C. for ten hours. Then, the container contents were subjected to a temperature increase to 150° C., being left as it was under a nitrogen atmosphere at 150° C. for five hours. Then, remaining volatile constituents were removed from the container contents by a nitrogen current to yield resin-containing particles (RA-1). The resin-containing particles (RA-1), containing a resin (more specifically, a polymerization product of methyl methacrylate, styrene, 3-methacryloxypropyl methyldiethoxysilane, and ethylene glycol dimethacrylate) and a surfactant (S-1a), had been surface treated with the surface treatment agent (IBTMS). <Resin-containing particles (RA-2)-(RA-5), (RB-1)-(RB-2), and (RB-4)-(RB-5) >

Resin-Containing Particles (RA-2)-(RA-5), (RB-1)-(RB-2), and (RB-4)-(RB-5) were prepared by the same process as in the preparation of the resin-containing particles (RA-1) except that the type and quantity of surfactants and the type and quantity of surface treatment agents were set as shown in Table 1 as well as that the reaction time X and the stirring rate Y were set as shown in Table 2.

$$〈 \text{Resin-containing particles} ( RB - 3 ) 〉$$

Resin-containing particles (RB-3) were prepared by the same process as in the preparation of the resin-containing particles (RA-1) except that untreated particles were used as the resin-containing particles (RB-3) without being sprayed with the surface treatment agent.

### Synthesization of Binder Resin

Polyester resin PE to be used as the binder resin in preparation process of toner mother particles was synthesized by the following process. A reaction container equipped with a thermometer (thermocouple), a dehydration tube, a nitrogen introducing tube, and a stirring blade was set to an oil bath. Thrown into this reaction container were 1575 g of bisphenol A propylene oxide adduct (BPA-PO), 163 g of bisphenol A ethylene oxide adduct (BPA-EO), 377 g of fumaric acid, and 4 g of dibutyltin oxide as a catalyst. Subsequently, after the reaction container inside was set to a nitrogen atmosphere, temperature of the reaction container inside was raised to 220°° C. by using the oil bath while contents of the reaction container were being stirred. The contents of the reaction container were allowed to react in polymerization for eight hours under conditions of the nitrogen atmosphere and the temperature of 220° C. while by-product water was being removed. Subsequently, after the reaction container inside was reduced in pressure, the contents of the reaction container were allowed to react in polymerization for further one hour under conditions of the pressure-reduced atmosphere (pressure: 60 mmHg) and the temperature of 220° C. Subsequently, after the temperature of the reaction container inside was lowered to 210° C., 336 g of anhydrous trimellitic acid was added into the reaction container. Then, the contents of the reaction container were thrown into polymerization reaction under conditions of the pressure-reduced atmosphere (pressure: 60 mmHg) and the temperature of 210° C. Thereafter, a reaction product was taken out from the reaction container, following by cooling the product, by which amorphous polyester resin PE was obtained.

### Preparation of Toner

Individual toners as shown in Table 3 below were prepared by the following process.

$$〈 Toner ( T - A 1 ) 〉$$

### (Preparation Process of Toner Mother Particles)

With use of an FM mixer (“FM-10B” made by Nippon Coke & Engineering Co., Ltd.), 100 parts by mass of a binder resin, 4 parts by mass of a colorant, 1 part by mass of a charge control agent, and 5 parts by mass of a mold releasing agent were mixed together to yield a mixture. The binder resin was given by the polyester resin PE as obtained above. The colorant was given by copper phthalocyanine blue pigment (C.I. Pigment Blue 15:3). The charge control agent was given by quaternary ammonium salt (“BONTRON (trademark) P-51” made by Orient Chemical Industries Co., Ltd.). The mold releasing agent was given by Carnauba Wax (“Special-make carnauba wax No. 1” made by S. KATO & CO.). While a resulting mixture was being melted and kneaded by using a twin screw extruder (“PCM-30 Model” made by Ikegai Corp) to yield a kneaded product. Kneading was executed under conditions of a set temperature of 120°0 C., a rotational speed of 150 rpm, and a processing quantity of 5 kg/hour. The kneaded product was ground by using a mechanical grinder (“Turbo mill” made by Freund-Turbo Corporation) to yield a ground product. The ground product was classified by a classifier (“Elbow-Jet” made by Nittetsu Mining Co., Ltd.). As a result, powder-state toner mother particles having a D₅₀ value of 6.8 μm were obtained.

### (External Addition Process)

With use of an FM mixer (“FM-10B” made by Nippon Coke & Engineering Co., Ltd.), 100.0 parts by mass of toner mother particles, 1.5 parts by mass of silica particles, and 1.0 part by mass of resin-containing particles (RA-1) were mixed together under a condition of 4,000 rpm for five minutes. The silica particles were given by “AEROSIL (trademark) REA90” made by Nippon Acrosil Co., Ltd. (dry-type silica particles with positive chargeability imparted by surface treatment and with a number-base-mean primary particle diameter of 20 nm). As a result of the mixing, external additives (silica particles and resin-containing particles (RA-1)) had been made adherent to the toner mother particles. The resulting mixture was sieved with a 200-mesh sieve (with 75 μm apertures), by which toner (T-A1) was obtained.

$$〈 Toners ( T - A 2 ) - ( T - A 7 ) and ( T - B 1 ) - ( T - B 7 ) 〉$$

Toners (T-A2)-(T-A7) and (T-B1)-(T-B7) were prepared by the same process as in the preparation of the toner (T-A1) except that type and quantity of the resin-containing particles used in the external addition process were set as shown in Table 3 below.

### Measurement

Specified coverage rates of individual toners were measured by the following process. Measurement results are shown in Table 3 below.

### <Specified Coverage Rate>

Backscattered electron images (surface picked-up images) of toner particles contained in toners were obtained with use of a field emission scanning electron microscope (FE-SEM) (“JSM-7600F” made by JEOL Ltd.). Specified coverage rates were determined by executing image analysis of the surface picked-up images obtained by using image analysis software (“WinROOF” made by Mitani Corporation). Each specified coverage rate corresponds to an area ratio of a region covered by the resin-containing particle out of a surface region of the toner mother particle. It is noted that with respect to sites where plural types of external additive particles were overlappingly present on the surfaces of the toner mother particles, those sites were decided as being covered by external additive particles present on the outermost side (in more detail, external additive particles present at the highest position relative to the surfaces of the toner mother particles). For example, sites where silica particles and resin-containing particles were overlapping in this order on the surfaces of the toner mother particles were decided as being covered by the resin-containing particles present on the outermost side. Specified coverage rates were measured for ten fields of view per toner particle, and an arithmetic mean of the resulting ten measured values was determined as a specified coverage rate of the relevant toner.

### Evaluation

Transferability and charging stability of individual toners were evaluated by the following method. Evaluation results are shown in Table 3 below.

### Preparation of Two-Component Developer

First, a two-component developer to be used for individual evaluations was prepared. The two-component developer for evaluation was obtained by mixing together 100 parts by mass of a carrier and 8 parts by mass of toner (evaluation-object toner whichever is (T-A1)-(T-A7) or (T-B1)-(T-B7)) for 30 minutes with use of a ball mill.

The carrier was prepared by the following process. Mixed together with use of a homomixer were 361.2 g of a silicone resin solution (“KR-255” made by Shin-Etsu Chemical Co., Ltd. with a solid content concentration of 50 mass %), 9.0 g of barium titanate (“BT-01” made by Sakai Chemical Industry Co., Ltd. with a number-base-mean primary particle diameter of 102 nm), 5.4 g of carbon black (“Ketjenblack EC-300J” made by LION SPECIALTY CHEMICALS CO., LTD.), and 1444.8 g of toluene, by which a coating liquid was obtained. With use of a fluidized bed coating machine (“FD-MP-01 D-Model” made by Powrex Corporation), while 5000 g of carrier cores were being fluidized, the coating liquid was sprayed to the carrier cores. In this way, carrier cores coated with the coating liquid were obtained. The coating was executed under conditions of a supply air temperature of 75° C., a supply air quantity of 0.3 m³/min., and a rotor rotational speed of 400 rpm. The carrier cores were given by manganese ferrite cores (made by DOWA IP Creation Co., Ltd., D₅₀ : 20.3 μm, saturation magnetization: 67 emu/g). The carrier cores coated with the coating liquid were fired for one hour at a temperature of 200° C. by using an electric furnace. In this way, coats were formed on surfaces of the carrier cores, by which a carrier was obtained.

### <Evaluation Apparatus>

As an evaluation apparatus to be used for each evaluation, a multifunction peripheral (“TASKalfa 6054c” made by KYOCERA Document Solutions Japan Inc.) was used. The two-component developer prepared in the above description was thrown into a developing unit of the evaluation apparatus, and resupply toner (any one of evaluation-object toners (T-A1)-(T-A7) and (T-B1)-(T-B7)) was thrown into a toner container of the evaluation apparatus.

### <Transferability>

An image with a coverage rate of 5% was printed on 10,000 sheets of paper by the evaluation apparatus under an environment of a temperature of 20° C. and a humidity of 50% RH. Then, masses of consumed toner and masses of collected toner were measured respectively, and transfer efficiencies (unit: %) were calculated from the following equation. It is noted that consumed toner refers to toner discharged from a toner container out of toner set in the toner container. Also, collected toner refers to toner not transferred to printing sheets out of the consumed toner. From each obtained transfer efficiency, transferability was determined by the following criteria:

$$transfer efficiency = 100 \times ( mass of consumed toner - mass of collected toner ) / ( mass of consumed toner )$$

### (Criteria for Transferability)

A (good): 90% or more transfer efficiency
B (poor): less than 90% transfer efficiency

### <Charging Stability>

An image with a coverage rate of 5% was printed on 500 sheets of paper with the evaluation apparatus under an environment of a temperature of 20° C. and a humidity of 50% RH. After the printing of 500 sheets, charging level (initial charging level A) of toner was measured. Then, with the evaluation apparatus, an image with a coverage rate of 5% was printed on 100,000 sheets. After the printing of 100,000 sheets, toner charging level (after-lasting-printing charging level B) was measured. From an equation “charging level difference =initial charging level A-after-lasting-printing charging level B,” a charging level difference was determined. In addition, for measurement of charging level of toner, with use of a Q/m meter (“MODEL 212HS-F” made by Trek, Inc.) and by suction through a sieve (wire netting), only toner was sucked up from the two-component developer deposited on a magnet roller included in the developing unit of the evaluation apparatus, thus enabling measurement of toner charging level. From resulting charging level differences, charging stability was determined by the following criteria:

### (Criteria for Charging Stability)

A (especially good): charging level difference is less than 4 μC/g;
B (good): charging level difference is not less than 4 μC/g and less than 8 μC/g; and
C (poor): charging level difference is not less than 8 μC/g.

Table 3 is as follows. It is noted that “EX1” denotes Example 1. “EX2” denotes Example 2. “EX3” denotes Example 3. “EX4” denotes Example 4. “EX5” denotes Example 5. “EX6” denotes Example 6. “EX7” denotes Example 7. “CEX1” denotes Comparative Example 1. “CEX2” denotes Comparative Example 2. “CEX3” denotes Comparative Example 3. “CEX4” denotes Comparative Example 4. “CEX5” denotes Comparative Example 5. “CEX6” denotes Comparative Example 6. “CEX7” denotes Comparative Example 7.

TABLE 3

| | | | | | Evaluation | | | |
|---|---|---|---|---|---|---|---|---|
| | | Resin-containing particles | | | | | Charging stability | |
| | | | | Specified | Transferability | | Charging | |
| | | | | coverage | Transfer | | level | |
| | | | Quantity | rate | efficiency | Deci- | difference | Deci- |
| | Toner | Type | [parts] | [%] | [%] | sion | [μC/g] | sion |
| EX1 | T-A1 | RA-1 | 1.0 | 23 | 92 | A | 3 | A |
| EX2 | T-A2 | RA-2 | 1.0 | 20 | 91 | A | 4 | B |
| EX3 | T-A3 | RA-3 | 1.2 | 20 | 93 | A | 7 | B |
| EX4 | T-A4 | RA-4 | 0.8 | 24 | 91 | A | 7 | B |
| EX5 | T-A5 | RA-1 | 1.3 | 29 | 94 | A | 6 | B |
| EX6 | T-A6 | RA-1 | 0.7 | 16 | 90 | A | 7 | B |
| EX7 | T-A7 | RA-5 | 1.0 | 22 | 91 | A | 5 | B |
| CEX1 | T-B1 | RB-1 | 1.0 | 22 | 84 | B | 6 | B |
| CEX2 | T-B2 | RB-2 | 0.9 | 23 | 86 | B | 6 | B |
| CEX3 | T-B3 | RB-3 | 1.0 | 25 | 82 | B | 7 | B |
| CEX4 | T-B4 | RB-4 | 1.3 | 20 | 91 | A | 9 | C |
| CEX5 | T-B5 | RB-5 | 0.8 | 22 | 87 | B | 9 | C |
| CEX6 | T-B6 | RA-1 | 1.4 | 31 | 94 | A | 8 | C |
| CEX7 | T-B7 | RA-1 | 0.6 | 13 | 86 | B | 6 | B |

In Table 3, “quantity” of resin-containing particles refers to addition quantity of resin-containing particles relative to 100.0 parts by mass of toner mother particles. “Parts” refers to parts by mass.

With regard to toner (T-B1), a surfactant contained in resin-containing particles (more specifically, surfactant (S-3C) contained in resin-containing particles (RB-1)) was a cationic surfactant, not anionic surfactant. Transfer efficiency of the toner (T-B1) was evaluated as poor. The reason of this is considered that resin-containing particles containing a cationic surfactant were stronger in positive chargeability than when containing an anionic surfactant, causing electrostatic adhesion force of toner particles to the photosensitive drum to be increased.

With regard to toner (T-B2), a surfactant contained in resin-containing particles (more specifically, surfactant (S-4n) contained in resin-containing particles (RB-2)) was a nonionic surfactant, not anionic surfactant. Transfer efficiency of the toner (T-B2) was evaluated as poor. The reason of this is considered that resin-containing particles containing a nonionic surfactant were stronger in positive chargeability than when containing an anionic surfactant, causing electrostatic adhesion force of toner particles to the photosensitive drum to be increased.

With regard to toner (T-B3), resin-containing particles (more specifically, resin-containing particles (RB-3)) were not surface treated with a silane coupling agent. Transfer efficiency of the toner (T-B3) was evaluated as poor. The reason of this is considered that resin-containing particles were not surface treated with a silane coupling agent, causing adhesion force of the resin-containing particles to the photosensitive drum to be increased.

With regard to toner (T-B4), resin-containing particles (more specifically, resin-containing particles (RB-4)) had a number-base-mean primary particle diameter of more than 100 nm. Charging stability of the toner (T-B4) was evaluated as poor. The reason of this is considered that resin-containing particles were more likely to be eliminated from the toner mother particles, causing eliminated resin-containing particles to adhere to the carrier, i.e., carrier contamination to arise.

With regard to toner (T-B5), resin-containing particles (more specifically, resin-containing particles (RB-5)) had a number-base-mean primary particle diameter of less than 60 nm. Transfer efficiency and charging stability of the toner (T-B5) were evaluated both as poor. The reason of this is considered that because of the number-base-mean primary particle diameter being less than 60 nm, the resin-containing particles did not function enough as a spacer intended for reduction in contact frequency between the photosensitive drum and the toner mother particles.

With regard to toner (T-B6), the specified coverage rate was more than 30%. Charging stability of the toner (T-B6) was evaluated as poor. The reason of this is considered that resin-containing particles were more likely to be eliminated from the toner mother particles, causing eliminated resin-containing particles to adhere to the carrier, i.e., carrier contamination to arise.

With regard to toner (T-B7), the specified coverage rate was less than 15%. Transfer efficiency of the toner (T-B7) was evaluated as poor. The reason of this is considered that because toner mother particles were not coated enough with resin-containing particles, the resin-containing particles did not function enough as a spacer intended for reduction in contact frequency between the photosensitive drum and the toner mother particles.

On the other hand, with regard to toners (T-A1)-(T-A7), external additives contained resin-containing particles in which resin was contained. The resin-containing particles further contained an anionic surfactant (more specifically, either one of surfactants (S-1a) and (S-2a)). The resin-containing particles had been surface treated with a silane coupling agent (more specifically, eight one of surface treatment agents (IBTMS) and (PTMS)). The resin-containing particles had a number-base-mean primary particle diameter within a range of 60 nm to 100 nm. Each specified coverage rate was within a range of 15% to 30%. Transfer efficiency of each of the toners (T-A1)-(T-A7) was evaluated as good, and their charging stability was evaluated as good or especially good.

From the above-described results, it has been proved that toners according to the present disclosure including toners (T-A1)-(T-A7) are high in transfer efficiency and superior in charging stability.

The toner according to the disclosure is utilizable, for example, for image formation in multifunction peripherals or printers.

What is claimed is:

1. A positively chargeable toner which contains toner particles, wherein:
each of the toner particles includes a toner mother particle, and an external additive adhering to a surface of the toner mother particle;
the external additive includes a resin-containing particle containing resin;
the resin-containing particle further contains an anionic surfactant;
the resin-containing particle is surface treated with a silane coupling agent;
a number-base-mean primary particle diameter of the resin-containing particles is within a range of 60 nm to 100 nm; and
an area ratio of a region covered by the resin-containing particle out of a surface region of the toner mother particle is within a range of 15% to 30%.

2. The positively chargeable toner according to claim 1, wherein
the anionic surfactant includes a sulfuric acid anionic group or a sulfonic acid anionic group.

3. The positively chargeable toner according to claim 1, wherein
the anionic surfactant exists in proximity to a surface of the resin-containing particle.

4. The positively chargeable toner according to claim 1, wherein
the resin is styrene acrylic resin including a silane bond.

5. The positively chargeable toner according to claim 1, wherein
the resin is a polymer of styrene or a derivative thereof, a (meth)acrylic acid or a derivative thereof, a silane compound having at least one (meth)acryloxy group, and a crosslinking agent having at least two unsaturated bonds.

6. The positively chargeable toner according to claim 1, wherein
content of the resin-containing particles is within a range of 0.7 part by mass to 1.3 parts by mass relative to 100.0 parts by mass of the toner mother particles.
